(19) United States
(12) Patent Application Publication
(10) Pub. No.: US 2026/0050433 A1
(43) Pub. Date: Feb. 19, 2026

(54) MANAGING UPDATE EVENTS FOR OBJECTS AT AN INFORMATION HANDLING SYSTEM

(71) Applicant: Dell Products L.P., Round Rock, TX (US)

(72) Inventors: Satyajeet Kumar, Bengaluru (IN); Sumit Kanhayalal Popli, Campbell, CA (US)

(21) Appl. No.: 18/761,591

(22) Filed: Jul. 2, 2024

(51) Int. Cl. G06F 8/658

(52) U.S. Cl. CPC G06F 8/658

(57) ABSTRACT

Receiving an update event for an object; determining that the update event is a partial update event that includes only dynamic data, and in response: determining that the object, stored at a storage device and corresponding to the update event, includes all required intents, and in response: updating the storage device to include the partial update event for the object, including a timestamp associated with the partial update event; and merging the partial update event with the object such that the object includes the partial update event, including the dynamic data of the partial update event.

### BACKGROUND

### Field of the Disclosure

The disclosure relates generally to an information handling system, and in particular, managing update events for objects at an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Caching is the practice of storing frequently accessed or computationally expensive data in a temporary location. Instead of recalculating or fetching the data from the original source (e.g., a database or external service), the system retrieves it from the cache.

### SUMMARY

Innovative aspects of the subject matter described in this specification may be embodied in a method of receiving an update event for an object; determining that the update event is a partial update event that includes only dynamic data, and in response: determining that the object, stored at a storage device and corresponding to the update event, includes all required intents, and in response: updating the storage device to include the partial update event for the object, including a timestamp associated with the partial update event; and merging the partial update event with the object such that the object includes the partial update event, including the dynamic data of the partial update event.

Other embodiments of these aspects include corresponding systems, apparatus, and computer programs, configured to perform the actions of the methods, encoded on computer storage devices.

These and other embodiments may each optionally include one or more of the following features. For instance, determining that the object, stored at a storage device, corresponding to the update event does not include all required intents, and in response: updating the storage device to include the partial update event for the object, including marking the partial update event as dirty. Determining that the update event is a full update event that includes immutable data and the dynamic data, and in response: updating the object stored at the storage device based on the full update event. Updating the object further includes determining that the object was previously stored at the storage device and updating the previously stored object. Updating the object further includes creating the object at the storage device. Identifying other partial update events associated with the object that are stored at the storage device; identifying a respective timestamp of each of the partial update events; comparing a timestamp of the update event with respective timestamps of other partial update events; and discarding the partial update events with respective timestamps older than the timestamp of the update event. Merging the partial update events with timestamps newer than the timestamp of the update event with the object.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing update events for objects.

FIG. 3 illustrates a method for managing update events for objects.

### DESCRIPTION OF PARTICULAR EMBODIMENT(S)

This disclosure discusses methods and systems for managing update events for objects. In short, improved processing is provided in an asynchronous environment for achieving low-cost and high-speed processing without the use of caching. This provides faster processing of data than traditional caching, saves on computational costs of caching, and can handle varying amounts of data and/or data requests, described further herein.

Specifically, this disclosure discusses a system and a method for receiving an update event for an object; determining that the update event is a partial update event that includes only dynamic data, and in response: determining that the object, stored at a storage device and corresponding to the update event, includes all required intents, and in response: updating the storage device to including the partial update event for the object, including a timestamp associated with the partial update event; and merging the partial update event with the object such that the object includes the partial update event, including the dynamic data of the partial update event.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

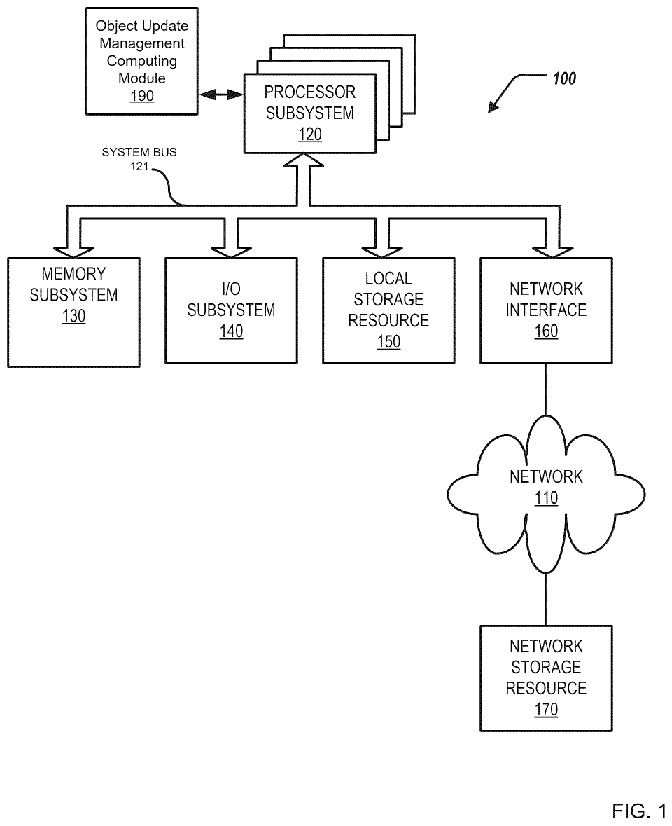

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include an object update management computing module 190. The object update management computing module 190 can be in communication with the processor subsystem 120, or included by the processor subsystem 120. In some examples, the object update management computing module 190 is included by an embedded controller (EC) of the information handling system 100. In some examples, the object update management computing module 190 is included by a baseband management controller of the information handling system 100.

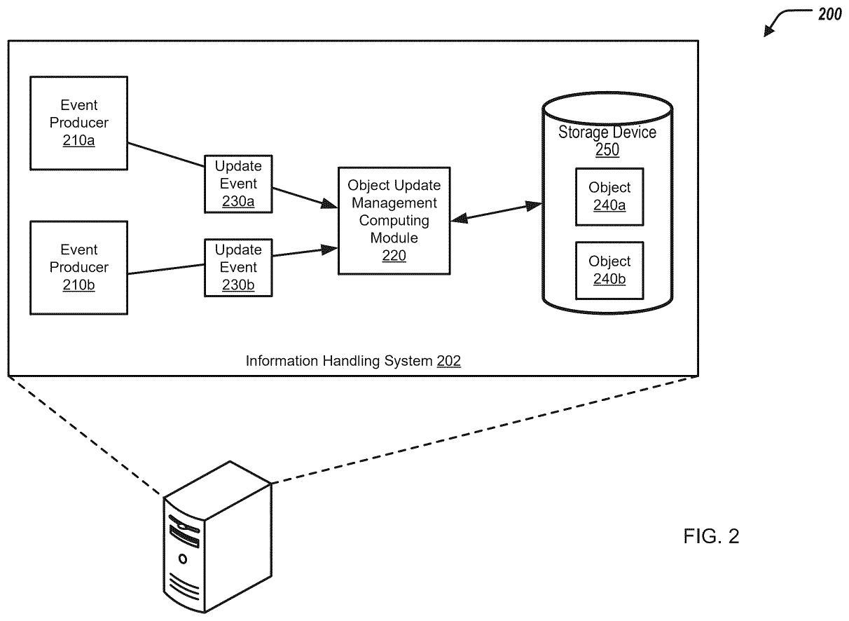

Turning to FIG. 2, FIG. 2 illustrates an environment 200 including an information handling system 202. The information handling system 202 can include event producers 210a, 210b (collectively referred to as event producers 210); however, the information handling system 202 can include any number of event producers. The information handling system 202 can further include an object update management computing module 220 and a storage device 250. In some examples, the information handling system 202 is similar to, or includes, the information handling system 100 of FIG. 1. In some examples, the object update management computing module 220 is the same, or substantially the same, as the object update management computing module 190 of FIG. 1.

The event producers 210 are in communication with the object update management computing module 220. The object management computing module 220 is in communication with the event producers 210 and the storage device 230.

The event producers 210 can generate update events 230—specifically, the event producer 210a can generate the update event 230a and the event producer 210b can generate the update event 230b. The update events 230 can be associated with objects 240a and 240b (e.g., tables, indexes, sequences, and the like) stored by the storage device 250. The storage device 250 can include any number of objects 240.

In some examples, an update event 230 can include immutable data—e.g., data that does not change, or rarely changes. For example, the immutable data can include data associated with an object 240 such as creation date, file name, author, and the like. For example, the immutable data can include data associated with an object 240 such as a service tag, a device ID, device hardware, and the like. In some examples, an update event 230 can include dynamic data—e.g., data that changes frequently. For example, the dynamic data can include data associated with an object such as size, description update date, updated by author, and the like. For example, the dynamic data can include updated values such as CPU usage, device attributes, and the like.

In some examples, the update event 230 can be a full update event. That is, a full update event can include immutable data and dynamic data, described further herein. In some examples, the update event 230 can be a partial update event. That is, the partial update can only include dynamic data, described further herein.

In short, the environment 200 provides improved processing and order of events in an asynchronous environment for achieving low-cost and high-speed processing without the use of caching. This provides faster processing of data than traditional caching, saves on computational costs of caching, and can handle varying amounts of data and/or data requests.

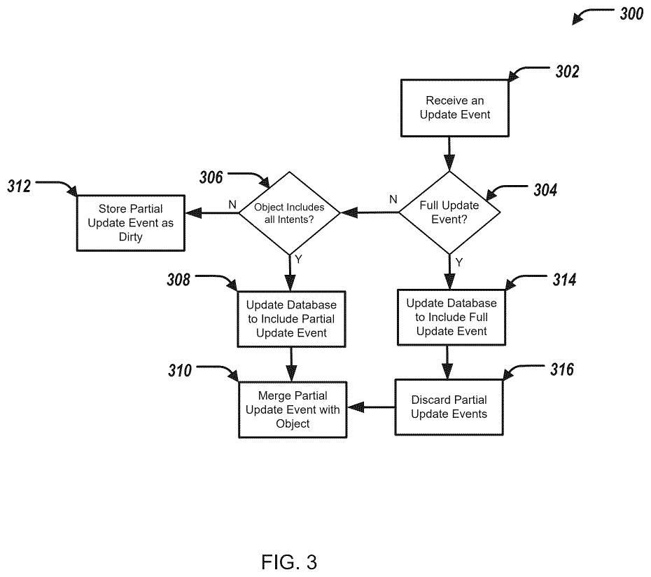

FIG. 3 illustrates a flowchart depicting selected elements of an embodiment of a method 300 for managing update events for objects. The method 300 may be performed by the information handling system 100, the information handling system 202, and/or the object update management computing module 220, and with reference to FIGS. 1-2. It is noted that certain operations described in method 300 may be optional or may be rearranged in different embodiments.

The object update management computing module 220 receives an update event 230a, at 302. Specifically, the event producer 210a can generate the update event 230a and transmit the update event 230a to the object update management computing module 220. The object update management computing module 220 can determine whether the update event 230a is a full update event or a partial update event, at 304. In some examples, the object update management computing module 220 determines that the update event 230a is a partial update event. That is, the object update management computing module 220 determines that the update event 230a only includes dynamic data. That is, the object update management computing module 220 determines that the update event 230a only includes dynamic data to update/overwrite some or all of the dynamic data of the object 240a associated with the update event 230a as stored by the storage device 250. In some examples, the object update management computing module 220 determines that the update event 230a does not include immutable data.

The object update management computing module 220, in response to determining that the update event 230a is a partial update event, determines whether the object 240a, stored at the storage device 250 and corresponding to the update event 230a, includes all required intents, at 306. That is, once all intents of the object 240a are consumed and processed, the object 240a is considered valid. An example of computer-language programming code for such can include:

```
Code example: var doc = db.runCommand({ “findAndModify” : “COLLECTION_NAME”,
  “query” : {“_id”: “ID_DOCUMENT”, “objectStatus” : “RUNNING”},
  “update” : {“$set” : {“objectStatus” : “IDLE”} }}).value
```

In other words, the object update management computing module 220 determines whether the object 240a, corresponding to the update event 230a, is stored by the storage device 250 (the object 240 “exists” in the storage device 250 as “complete”).

In some examples, the intents of the objects 240 refer to the purpose or action that an event is to achieve. For example, when an event occurs (such as a device check-in), an event object is created having complete device details. For example, a device registration (intent) event contains information about a registration of device, while a system update (intent) event contains details of new updates (or changes) in the device. An example payload of a check-in intent can include:

```
{
  “eventId”: “uuid”, //unique Id of the event
  “eventType”: “CREATE”,
  “intent”: “REGISTRATION”,
    “source”: “cms”, //name of the application publishing the event.
    “version”: “v1”, //version of the event, Example - v1, v2, etc.
  “timestamp”: 1659135289940,
  “entity”: {
      “_id”: null,
      “createdAt”: null,
      “id”: 268,
      “parentTenant”: “GRPTEST”,
      “tenant”: “Tenant_GrpAssc”,
      “updatedAt”: null,
      “isActive”: true,
      “name”: null,
      “modelNum”: null,
      “owner”: null,
      “modelName”: null,
      “productName”: null,
      “macAddress”: “31:70:01:21:C1:80”,
      “serialNum”: “b1cb9846-bee8”,
      “agentLocation”: null,
      “hardwareSummary”: null,
      “agentPackage”: null,
      “deviceType”: {
        “_id”: null,
        “createdAt”: 1647279401000,
        “id”: 39,
        “updatedAt”: null,
        “isActive”: true,
        “name”: “Windows PC”,
        “description”: “Windows PC”,
        “type”: 71,
        “parent”: {
          “_id”: null,
          “createdAt”: 1647278361000,
          “id”: 14,
          “updatedAt”: null,
          “isActive”: true,
          “name”: “Generic Thin Client”,
          “description”: “Generic Thin Client”,
          “type”: 18,
          “parent”: null,
          “isAssignable”: false,
          “family”: 18,
          “sortGroup”: 0,
          “isCategory”: true,
          “androidFamily”: false
        },
        “isAssignable”: true,
        “family”: 71,
        “sortGroup”: 16,
        “isCategory”: false,
        “androidFamily”: false
      },
      “deviceStatus”: {
        “_id”: null,
        “createdAt”: 1647279005000,
        “id”: 8,
        “updatedAt”: null,
        “isActive”: true,
        “name”: “PendingEnrollValidation”,
        “description”: “PendingEnrollValidation”,
        “type”: 6
      },
      “deviceImageInfo”: {
        “_id”: null,
        “createdAt”: null,
        “id”: 0,
        “updatedAt”: null,
        “isActive”: true,
        “imageVersion”: “5.6.0-1020-oem\n”,
        “merlinVersion”: null,
        “diskType”: 0,
        “imageBiosPullSupported”: true,
        “imageRecoveryPullSupported”: false,
        “isReimageSupported”: true,
        “dellBios”: false,
        “diskTypeString”: “”
      },
      “lastConfigChangeTime”: null,
      “deviceOsType”: {
        “_id”: null,
        “createdAt”: null,
        “id”: 0,
        “updatedAt”: null,
        “isActive”: true,
        “name”: “Windows 10 Professional 32-bit”,
        “description”: “Windows 10 Professional 32-bit”,
        “type”: 71,
        “deviceType”: null,
        “agentCode”: null,
        “osCode”: null
      },
      “devicePlatformType”: {
        “_id”: null,
        “createdAt”: null,
        “id”: 0,
        “updatedAt”: null,
        “isActive”: true,
        “name”: “STANDARD_DESKTOP”,
        “description”: “STANDARD_DESKTOP”,
        “type”: 521,
        “deviceType”: null,
        “oem”: −1,
        “hardware”: −1,
        “productName”: “STANDARD_DESKTOP”,
        “modelCode”: “0”,
        “manufacturer”: “Dell Inc.”
      },
      “wyseIdentifier”: “wyse1789269133615240005”,
      “ip”: null,
      “subnet”: null,
      “ipV6”: null,
      “ipv6Prefix”: null,
      “uptime”: null,
      “lastComplianceCheckTime”: null,
      “csDeviceId”: “62e46539c2d62670c9e10f75”,
      “staticGroupId”: “15”,
      “csGroupId”: “789d83d804fe8d068f2be68bc”,
      “online”: false
  }
}
```

In some examples, the object update management computing module 220 determines that the object 240a, corresponding to the update event 230a, includes all required intents. That is, the object update management computing module 220 determines that the object 240a, corresponding to the update event 230a, is a “full” object stored by the storage device 250. In response to the object update management computing module 220 determining that the object 240a, corresponding to the update event 230a, includes all required intents, the object update management computing module 220 updates the storage device 250 to include the update event 230a, at 308. Specifically, the object update management computing module 220 updates the storage device 250 to include the partial update event 230a for the object 240a that is associated with the update event 230a. In some examples, the update event 230a further includes a timestamp. The timestamp for the update event 230a can be in epoch format from the producer (event producer 210a) of the update event 230a. The object update management computing module 220 can further update the storage device 250 to include the timestamp of the partial update event 230a for the object 240a that is associated with the update event 230a.

The object update management computing module 220, further in response to determining that the object 240a, corresponding to the update event 230a, includes all required intents, merges the update event 230a with the object 240a that corresponds to the update event 230a, at 310. That is, the object update management computing module 220 merges the partial update event 230a with the object 240a such that the object includes the partial update event 230a. Specifically, the object update management computing module 220 merges the partial update event 230a with the object 240a such that the object 240a includes the partial update event 230a, including the dynamic data of the partial update event 230a. The object update management computing module 220 can merge the partial update event 230a with the object 240a such that the dynamic data of the partial update event 230a can overwrite any existing corresponding dynamic data of the object 240a stored at the storage device 250 and/or store the dynamic data of the partial update event 230a as new dynamic data at the storage device 250 corresponding to the object 240a. In some examples, the object update management computing module 220 can additionally merge the partial update event 230a with the object 240a, including merging the timestamps of the partial update event 230a with object 240a as stored by the storage device 250.

In some examples, the object update management computing module 220, in response to determining that the update event 230a is a partial update event, determines that the object 240a, stored at the storage device 250 and corresponding to the update event 230a, does not include all required intents (at 306). The object update management computing module 220, in response to determining that the object 240a, corresponding to the update event 230a, does not include all required intents, updates the storage device 250 to include the update event 230a, at 312. Specifically, the object update management computing module 220 updates the storage device 250 to include the partial update event 230a for the object 240a that is associated with the update event 230a. Moreover, the object update management computing module 220 updates the storage device 250 to include the partial update event 230a for the object 240a that is associated with the update event 230a, including marking the partial update event 230a as dirty. Specifically, when the update event 230a only includes a partial update event-only a dynamic part- and the storage device 250 does not include a “full” or “complete” object 240 corresponding to the partial update event 230a, or the object 240a stored in the storage device 250 only includes dynamic parts, the object update management computing module 220 declares the object 240a and the update event 230a as “dirty.” The object 240a is marked as dirty until it includes both static (immutable) and dynamic parts. The object 240a, when marked as dirty, is unavailable for query from users or other applications or computing modules. In some examples, the update event 230a further includes a timestamp. The timestamp for the update event 230a can be in epoch format from the producer (event producer 210a) of the update event 230a. The object update management computing module 220 can further update the storage device 250 to include the timestamp of the partial update event 230a for the object 240a that is associated with the update event 230a. The timestamp can indicate a time of generation of the partial update event 230a (e.g., by the event producer 210a).

In a further implementation, the object update management computing module 220 receives an update event 230b, at 302. Specifically, the event producer 210b can generate the update event 230b and transmit the update event 230b to the object update management computing module 220. The object update management computing module 220 can determine whether the update event 230b is a full update event or a partial update event, at 304. In some examples, the object update management computing module 220 determines that the update event 230b is a full update event. That is, the object update management computing module 220 determines that the update event 230b includes immutable data and dynamic data. That is, the object update management computing module 220 determines that the update event 230b includes immutable data and dynamic data to update/overwrite all parameters of the associated object 240b in the storage device 250.

In response to the object update management computing module 220 determining that the update event 230b is a full update event, the object update management computing module 220 updates the storage device 250 to include the update event 230b, at 314. Specifically, the object update management computing module 220 updates the storage device 250 based on the full update event-updates the storage device 250 to include the full update event for the object 240b that is associated with the update event 230b. In some examples, the update event 230b further includes a timestamp. The timestamp for the update event 230b can be in epoch format from the producer (event producer 210b) of the update event 230b. The object update management computing module 220 can further update the storage device 250 to include the timestamp of the full update event 230b for the object 240b that is associated with the update event 230b. In some examples, the object 240b associated with the full update event 230b is available for query from users or computer applications or computer-implemented modules. The timestamps can indicate a time of generation of the full update event 230b (e.g., by the event producer 210b).

In some examples, the object update management computing module 220 updates the object 240b that is associated with the update event 230b by determining that the object 240b was previously stored at the storage device 250. The object update management computing module 220 then updates this previously stored object to include the update event 230b.

In some examples, the object update management computing module 220 updates the object 240b that is associated with the update event 230b by creating the object 240b at the storage device 250. That is, the object 240b that is associated with the update event 230b did not previously exist or was not previously stored by the storage device 250. The object update management computing module 220 creates the object 240b for storage at the storage device 250 to include the update event 230b.

The object update management computing module 220 discards partial update events associated with the object 240b, at 316. Specifically, the object update management computing module 220 identifies other partial update events associated with the object 240b that corresponds to the update event 230b. That is, the storage device 250 can store previously received partial update events for the object 240b. The object update management computing module 220 identifies a respective timestamp of each of the partial update events. The timestamps can indicate a time of generation of the partial update events (e.g., by the event producers 210). The object update management computing module 220 compares the timestamp of the update event 230b with the respective timestamps of the other partial update events. The object management computing module 220 discards, based on the comparing, partial update events with respective timestamps older than the timestamp of the update event 230b.

The object update management computing module 220 merges partial update events with timestamps newer than the timestamp of the update event 230b with the object that corresponds to the update event 230b, at 310. That is, the object update management computing module 220 merges the partial update events with timestamps newer than the timestamp of the update event 230b with the object 240b that corresponds to the update event 230b such that the object 240b includes such partial update events.

In a use case example, during registration of a device, there can be three events which come immediately after one another (Registration, check-in, heartbeat). All three events can come within a few milliseconds. A device registry service can consume any of these events in any order for new device registration, which makes the device object dirty if it consumes a heartbeat event earlier to registration/check-in events. Once all of these three events are consumed and merged into the storage device 250, the object 240 is considered to be a valid device object.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method, comprising:
receiving an update event for an object;
determining that the update event is a partial update event that includes only dynamic data, and in response:
determining that the object, stored at a storage device and corresponding to the update event, includes all required intents, and in response:
updating the storage device to include the partial update event for the object, including a timestamp associated with the partial update event; and
merging the partial update event with the object such that the object includes the partial update event, including the dynamic data of the partial update event.

2. The computer-implemented method of claim 1, further including:
determining that the object, stored at a storage device, corresponding to the update event does not include all required intents, and in response:
updating the storage device to include the partial update event for the object, including marking the partial update event as dirty.

3. The computer-implemented method of claim 1, further including:
determining that the update event is a full update event that includes immutable data and the dynamic data, and in response:
updating the object stored at the storage device based on the full update event.

4. The computer-implemented method of claim 3, wherein updating the object further includes determining that the object was previously stored at the storage device and updating the previously stored object.

5. The computer-implemented method of claim 3, wherein updating the object further includes creating the object at the storage device.

6. The computer-implemented method of claim 4, further including:
identifying other partial update events associated with the object that are stored at the storage device;
identifying a respective timestamp of each of the partial update events;
comparing a timestamp of the update event with respective timestamps of other partial update events; and
discarding the partial update events with respective timestamps older than the timestamp of the update event.

7. The computer-implemented method of claim 6, further including:
merging the partial update events with timestamps newer than the timestamp of the update event with the object.

8. An information handling system comprising a processor having access to memory media storing instructions executable by the processor to perform operations, comprising:
receiving an update event for an object;
determining that the update event is a partial update event that includes only dynamic data, and in response:
determining that the object, stored at a storage device, corresponding to the update event includes all required intents, and in response:
updating the storage device to include the partial update event for the object, including a timestamp associated with the partial update event; and
merging the partial update event with the object such that the object includes the partial update event, including the dynamic data of the partial update event.

9. The computer-implemented method of claim 8, the operations further including:
determining that the object, stored at a storage device, corresponding to the update event does not include all required intents, and in response:
updating the storage device to include the partial update event for the object, including marking the partial update event as dirty.

10. The computer-implemented method of claim 8, the operations further including:
determining that the update event is a full update event that includes immutable data and the dynamic data, and in response:
updating the object stored at the storage device based on the full update event.

11. The computer-implemented method of claim 10, wherein updating the object further includes determining that the object was previously stored at the storage device and updating the previously stored object.

12. The computer-implemented method of claim 10, wherein updating the object further includes creating the object at the storage device.

13. The computer-implemented method of claim 11, the operations further including:
identifying other partial update events associated with the object that are stored at the storage device;
identifying a respective timestamp of each of the partial update events;
comparing a timestamp of the update event with respective timestamps of other partial update events; and
discarding the partial update events with respective timestamps older than the timestamp of the update event.

14. The computer-implemented method of claim 13, the operations further including:
merging the partial update events with timestamps newer than the timestamp of the update event with the object.

15. A non-transitory computer-readable medium storing software comprising instructions executable by one or more computers which, upon such execution, cause the one or more computers to perform operations comprising:
receiving an update event for an object;
determining that the update event is a partial update event that includes only dynamic data, and in response:
determining that the object, stored at a storage device, corresponding to the update event includes all required intents, and in response:
updating the storage device to include the partial update event for the object, including a timestamp associated with the partial update event; and
merging the partial update event with the object such that the object includes the partial update event, including the dynamic data of the partial update event.

16. The computer-implemented method of claim 15, the operations further including:
determining that the object, stored at a storage device, corresponding to the update event does not include all required intents, and in response:
updating the storage device to include the partial update event for the object, including marking the partial update event as dirty.

17. The computer-implemented method of claim 15, the operations further including:
determining that the update event is a full update event that includes immutable data and the dynamic data, and in response:
updating the object stored at the storage device based on the full update event.

18. The computer-implemented method of claim 17, wherein updating the object further includes determining that the object was previously stored at the storage device and updating the previously stored object.

19. The computer-implemented method of claim 17, wherein updating the object further includes creating the object at the storage device.

20. The computer-implemented method of claim 18, the operations further including:
identifying other partial update events associated with the object that are stored at the storage device;
identifying a respective timestamp of each of the partial update events;
comparing a timestamp of the update event with respective timestamps of other partial update events; and
discarding the partial update events with respective timestamps older than the timestamp of the update event.
